(19) United States
(12) Patent Application Publication
(10) Pub. No.: US 2015/0181294 A1
(43) Pub. Date: Jun. 25, 2015

(54) METHOD AND SYSTEM FOR PROVIDING AND RECEIVING MULTI-SCREEN BASED CONTENT

(71) Applicant: Electronics and Telecommunications Research Institute, Daejeon (KR)

(72) Inventors: Jae-Ho KIM, Nonsan-si (KR); Jeong-Ju YOO, Daejeon (KR); Jin-Woo HONG, Daejeon (KR)

(73) Assignee: Electronics and Telecommunications Research Institute, Daejeon (KR)

(21) Appl. No.: 14/257,116

(22) Filed: Apr. 21, 2014

(30) Foreign Application Priority Data
Dec. 19, 2013 (KR) 10-2013-0159616

(51) Int. Cl. H04N 21/462; H04N 21/643; H04N 21/41; H04N 21/4223; H04N 21/435

(52) U.S. Cl. CPC H04N 21/4622; H04N 21/4223; H04N 21/435; H04N 21/4122; H04N 21/64322

(57) ABSTRACT

In a method and system for providing and receiving multi-screen based content, the method for providing multi-screen based content includes providing a user with secondary content in real time through a secondary terminal including at least one screen, in which the secondary content is related to primary content reproduced through a primary terminal.

### CROSS-REFERENCE TO RELATED APPLICATION(S)

This application claims priority from Korean Patent Application No. 10-2013-0159616, filed on Dec. 19, 2013, in the Korean Intellectual Property Office, the entire disclosure of which is incorporated herein by reference for all purposes.

### BACKGROUND

1. Field

The following description relates to a broadcast system and service technology.

2. Description of the Related Art

Smart TVs have been attracting attention recently as people use the smart TV to view broadcast content provided by broadcasting stations, as well as to access broadband network to enjoy Internet services. The smart TV uses Internet network to provide services, including all on-line or off-line content ranging from content provided by service providers to programs produced and provided by professional developers or unspecified consumers. Further, unlike the Internet Protocol Television (IPTV), which is partly interactive, the smart TV supports full interactivity between broadcast service providers and broadcast service users.

### SUMMARY

According to an exemplary embodiment, a method and system for providing multi-screen based content is provided, in which by combining broadcast and the Internet, content may be provided to users via a terminal with at least one screen.

According to an exemplary embodiment, there is disclosed a method for providing multi-screen based content of a primary terminal, the method includes: connecting to at least one of secondary terminals each with a screen; tracking an eye gaze of a user that uses primary content through the primary terminal to detect an eye movement of the user from the primary terminal to the at least one secondary terminal; and in response to detecting the eye movement of the user, transmitting, to the at least one secondary terminal, context information required for the at least one secondary terminal to receive secondary content related to the primary content.

According to another exemplary embodiment, there is disclosed a method for receiving multi-screen based content of at least one of secondary terminals each with a screen, the method includes: connecting to a primary terminal that receives and displays primary content; detecting an eye movement from the primary terminal to the at least one secondary terminal of a user viewing the primary content through the primary terminal; in response to detecting the user's eye movement, requesting and receiving, from the primary terminal, context information on the primary content; and transmitting user information along with the received context information to a content provider to receive secondary content related to the primary content from the content provider.

According to still another exemplary embodiment, there is disclosed a method for providing multi-screen based content of a primary terminal, the method includes: connecting to at least one of secondary terminals each with a screen; obtaining metadata of secondary content related to primary content reproduced through the primary terminal; analyzing the obtained metadata of the secondary content to detect a point of reproduction of the primary content related to the secondary content, and to display a content notification interface at the detected reproduction point; and based on the displayed content notification, when an instruction to receive the secondary content is input to the at least one secondary terminal from a user through a content request interface, providing context information to the at least one secondary terminal at the request of the at least one secondary terminal.

### BRIEF DESCRIPTION OF THE DRAWINGS

FIG. 1 is a block diagram illustrating an example of a multi-screen service system according to an exemplary embodiment.

FIG. 2 is a block diagram illustrating an example of providing multi-screen based content.

FIG. 3 is a flowchart illustrating an example of a method for providing multi-screen based content of FIG. 2.

FIG. 4 is a block diagram illustrating another example of providing multi-screen based content.

FIG. 5 is a flowchart illustrating another example of a method for providing multi-screen based content of FIG. 4.

FIG. 6 is a detailed block diagram illustrating an example of a primary terminal and a secondary terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the multi-angle view processing apparatus will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

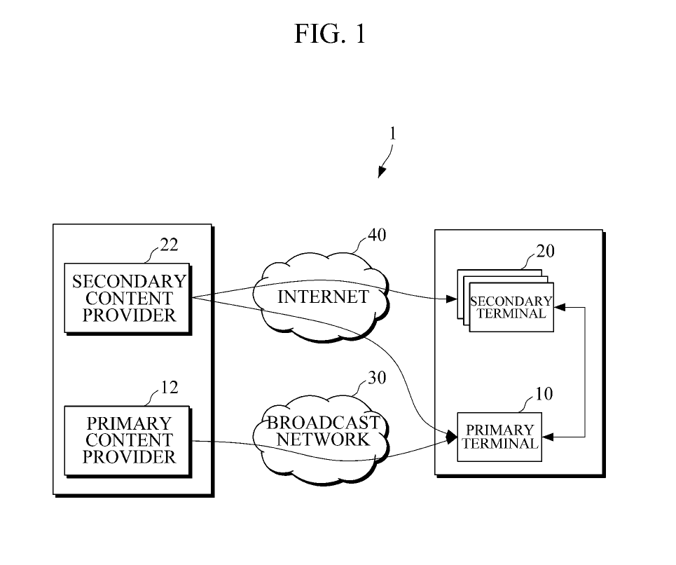

FIG. 1 is a block diagram illustrating an example of a multi-screen service system according to an exemplary embodiment.

Referring to FIG. 1, the multi-screen service system 1 includes a primary terminal 10, a primary content provider 12, a secondary terminal 20, a secondary content provider 22, a broadcast network 30 and Internet 40.

The primary terminal 10 receives primary content from the primary content provider 12, and displays the received primary content on its screen, in which the primary content may be broadcast content. In this case, the primary terminal 10 may receive broadcast content from the primary content provider 12 through the broadcast network 30. The broadcast content may be real-time broadcast content, but may also be non-real time broadcast content. The primary terminal 10 is a broadcast receiver that receives broadcast content through the broadcast network 30, such as an IPTV, or a smart TV.

The secondary terminal 20 is a plurality in number, each with a screen. The secondary terminal 20 displays, on each screen of the plurality of secondary terminals 20, secondary content related to the primary content displayed on a screen of the primary terminal 10. The secondary terminal 20 may receive the secondary content from the secondary content provider 22 through the Internet 40.

A group of the plurality of secondary terminals 20, each with a screen, is referred to as a “multi-screen device”, and the secondary content displayed on a screen of the multi-screen device is referred to as “multi-screen content”. The “multi screens” indicate at least one group of screens, and the “multi-screen content” indicates that the secondary content is provided on multiple screens. The multi-screen content may be provided as a service. The multi-screen content provided to each of the secondary terminals may be different from each other. Further, users of each of the secondary terminals may be identical to or different from each other. In this case, the multi-screen content may be customized content provided for each user or each terminal. The multi-screen content may also be augmented content.

The present disclosure relates to a technology for providing content in such a manner that primary content is provided through the primary terminal 10, and then secondary content related to the primary content is provided through each screen of the secondary terminals 20 of a user. For example, while a user is viewing a broadcast program via the primary terminal 10, e.g. a smart TV, the user may be provided with multi-screen content related to the broadcast program through the secondary terminal 20, e.g. a smart device carried by the user. In this case, multi-screen content related to the broadcast program may be provided in real time using a plurality of smart devices at the same time.

Hereinafter, each constituent element of the multi-screen service system 1 will be described in detail. For convenience, it is assumed that the primary content is broadcast content provided through a broadcast network 30, the secondary content related to the primary content is multi-screen content provided through the Internet 40 and related to broadcast content, but the primary content and the secondary content are not limited thereto.

The primary content provider 12 provides broadcast content to the primary terminal 10 through the broadcast network 30. The broadcast content may be a broadcast program or a specific scene or object in the broadcast program. The primary content provider 12 may transmit broadcast content through a one-way broadcast network, such as a ground-wave, cable, or satellite network. Alternatively, broadcast content may be transmitted through bidirectional network, such as an IPTV network. The primary content provider 12 may be a cable TV provider that provides IPTV or smart TV services, or the like.

The secondary content provider 22 provides multi-screen content to the secondary terminal 20, in which the multi-screen content may be additional content related to broadcast content. The additional content may be multi-media data, which may be content such as photographs, music, or texts. The additional content may be provided as services, which may be various types of services provided on the Internet, such as online searching, movies, music, home shopping, home banking, online games, travel, map information, and the like.

The secondary terminal 20 is connected to the Internet through a wired or wireless network so as to allow web browsing, and has a computing function. The secondary terminal 20 may be a smart device, such as a smartphone, a smart pad, or a smart TV. Specifically, the secondary terminal 20 may be a portable terminal that users may carry with them.

The primary terminal 10 and the secondary terminal 20, each with a screen, are terminals carried by a user. The primary terminal 10 and the secondary terminal 20 may be located in a home, in which the primary terminal 10 may be, for example, an IPTV, or a smart TV, that has a screen used commonly by family members, and may be connected to the broadcast network 30 or the Internet network 40. The broadcast content is transmitted to the primary terminal 10 through the broadcast network 30, and multi-screen content related to the broadcast content is transmitted to the secondary terminal 20 through the Internet 40. The multi-screen content may be transmitted to the primary terminal 10 or the secondary terminal 20.

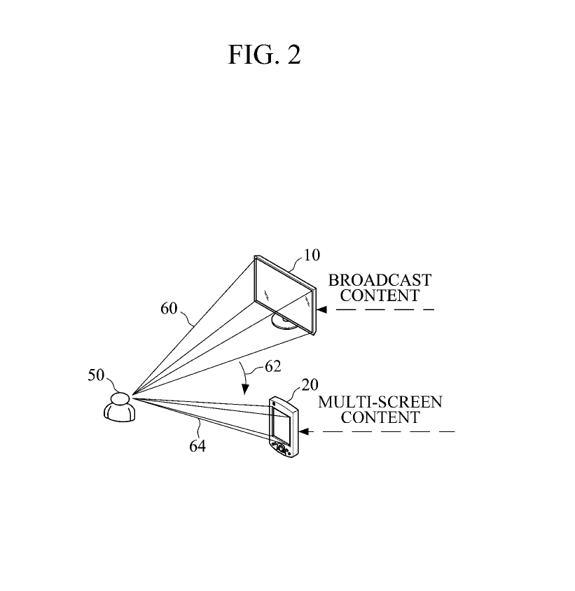

FIG. 2 is a block diagram illustrating an example of providing multi-screen based content. Specifically, FIG. 2 illustrates a user interface for displaying multi-screen content on a screen of the secondary terminal 20 by using information on eye gaze recognition and tracking of a user of multi-screen services. The multi-screen content is additional content related to broadcast content reproduced on a screen of the primary terminal 10.

As illustrated in FIG. 2, the primary terminal 10 is a smart TV, and the secondary terminal 20 may be a multi-screen device, such as a smartphone that may be carried by a user. Hereinafter, a method for providing multi-screen content will be described on an assumption that the primary terminal 10 and the secondary terminal 20 are connected to indoor wireless LAN.

A multi-screen service user (hereinafter referred to as a “user”) 50 uses a primary terminal 10 to view broadcast content, while using the secondary terminal 20 at the same time. While the user 50 is viewing broadcast content through the primary terminal 10, if the user 50 wishes to receive additional information on an object of interest in a scene of interest, the user's eye gaze is directed to the secondary terminal 20. The primary terminal 10 may detect an object of interest and a scene of interest using eye gaze tracking information immediately before the user 50 turns their eyes away from the primary terminal 10. By tracking the eye gaze, information on eye gaze movement between the primary terminal 10 and the secondary terminal 20 may be obtained to identify a user's interest, enabling a user to consume multi-screen content based on broadcast content.

Reference numeral 60 in FIG. 2 denotes that a user's eye gaze is directed to the primary terminal 10, reference numeral 62 denotes a shift of a user's eye gaze from the primary terminal 10 to the secondary terminal 20, and reference numeral 64 denotes that a user's eye gaze is directed to the secondary terminal 20.

As for a technology for recognizing and tracking eye gaze, existing technologies as well as technologies now under development may be used. For example, a user's face is identified from a user's image captured from a camera, and detects an eye area of the face. Then, a time when a user's eye gaze is focused is measured, and a point where the eye gaze is focused is identified, so as to detect a scene of interest and an object of interest on that focused point.

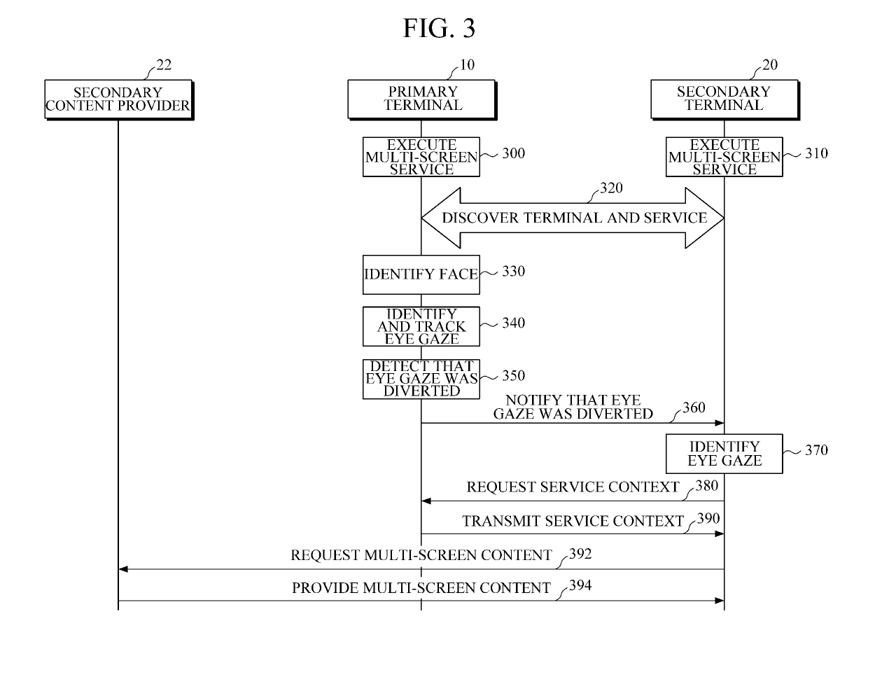

FIG. 3 is a flowchart illustrating an example of a method for providing multi-screen based content of FIG. 2. Specifically, FIG. 3 is a flowchart illustrating an example method of providing multi-screen based content using eye gaze recognition and tracking.

Referring to FIG. 3, a user executes a multi-screen service of the primary terminal 10 to view broadcast content through a screen in 300. At the same time, the user also executes a multi-screen service of the secondary terminal 20 in 310, so as to use the secondary terminal 20 as a secondary screen. In this case, when the primary terminal 10 and the secondary terminal 20 are connected to an identical indoor network, the two terminals discover each other and each other's services in 320, using a home networking technology (e.g. UPnP, mDNS, Bonjour, etc.).

Subsequently, the primary terminal 10 identifies a face of a user viewing broadcast content in 330, recognizes eye gaze of the user whose face is identified, and tracks the eye gaze in 340. In this case, when it is detected in 350 that the user's eye gaze has diverted from the primary terminal 10, a message notifying that the eye gaze was diverted is transmitted in 360 to the secondary terminal 20 carried by the user. The secondary terminal 20 that received the message recognizes an eye gaze in 370 to determine whether the user's eye gaze is directed to the secondary terminal 20.

In response to a determination that the user is gazing at a screen of the secondary terminal 20, the secondary terminal 20 transmits a message of request for service context information to the primary terminal 10 in 380. After receiving the message, the primary terminal 10 transmits a service context response message including service context information to the secondary terminal 20 in 390. The service context information may include content identification (ID), content metadata, a point in time where a user's eye gaze is diverted, and coordinates of a tracked eye gaze immediately before the eye gaze is diverted.

Then, the secondary terminal 20 transmits a message of request for multi-screen content that includes user information along with received service context information to the secondary content provider 22 in 392. The user information includes not only a user identifier that identifies a user of the secondary terminal 20, but also terminal information on the secondary terminal 20. The terminal information may include a terminal identifier, a multi-screen service connection status of a terminal, etc.

After receiving the message of request for multi-screen content, the secondary content provider 22 produces multi-screen content based on broadcast content by using service context information, and provides the produced multi-screen content to the secondary terminal 20 by using user information in 394.

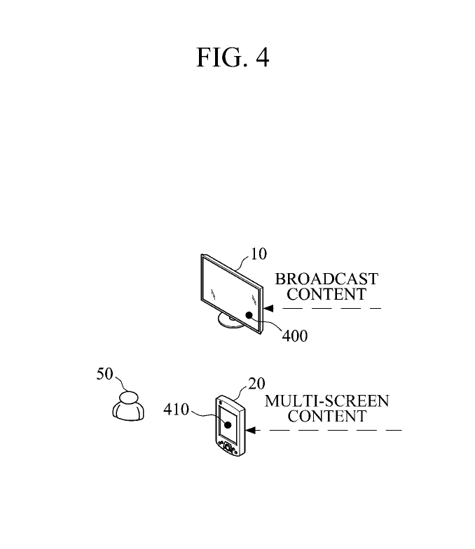

FIG. 4 is a block diagram illustrating another example of providing multi-screen based content. Specifically, FIG. 4 illustrates an example of providing multi-screen content by using a content notification interface 400 of the primary terminal 10 and a content request interface 410 of the secondary terminal 20.

While using the primary terminal 10, such as viewing a smart TV, the user 50 at the same time uses the secondary terminal 20, such as a portable multi-screen device. The primary terminal 10, while reproducing broadcast content, receives metadata of multi-screen content related to the broadcast content via a broadcast network, or the Internet. At a specific point where the primary terminal 10 reproduces broadcast content, the content notification interface 400 that notifies that multi-screen content is included is displayed on a screen. The user 50 recognizes the content notification interface 400 while viewing broadcast content through the primary terminal 10, and uses the content request interface 410 of the secondary terminal 20 to request and consume multi-screen content.

The content notification interface 400 and the content request interface 410 mentioned above correspond to a function of a user interface, such as a red button displayed on a screen for users of HbbTV service (i.e. hybrid broadcast TV) to consume Internet content through TV while viewing broadcast programs. The HbbTV service, which combines broadcast and the Internet, may provide additional content and bidirectional content through the Internet while viewing broadcast content.

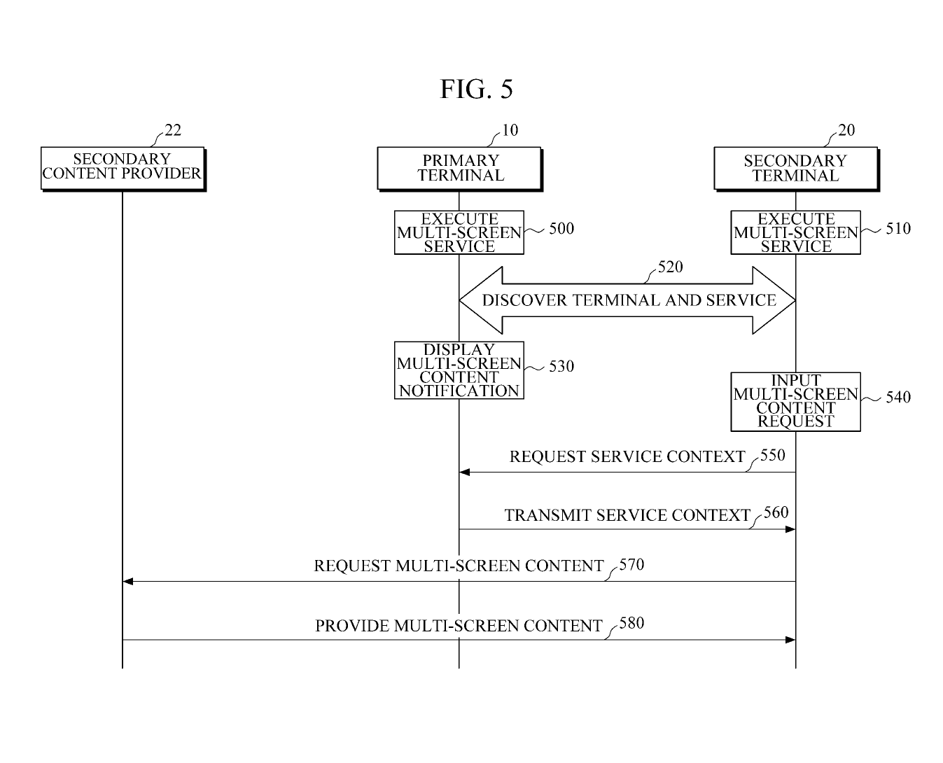

FIG. 5 is a flowchart illustrating another example of a method for providing multi-screen based content of FIG. 4. Specifically, FIG. 5 a flowchart illustrating an example method of providing multi-screen content by using a content notification interface and a content request interface.

Referring to FIGS. 4 and 5, the user 50 executes a multi-screen service of the primary terminal 10 in 500 to view broadcast content. At the same time, the user 50 executes a multi-screen service of the secondary terminal 20 to use the secondary terminal 20 as a secondary screen in 510. In this case, when the primary terminal 10 and the secondary terminal 20 are connected to an identical wireless network in a home, the primary terminal 10 and the secondary terminal 20 discover each other and each other's services in 520 using a home networking technology (e.g. UPnP, mDNS, Bonjour, etc.).

Subsequently, the primary terminal 10 receives multi-screen content metadata through a broadcast network or the Internet, and analyzes the received metadata to display a content notification interface on a screen at a predetermined point of broadcast content reproduction in 530. At this point, a content request interface is displayed on the secondary terminal 20, and the user 50 uses the content request interface to input multi-screen content request instruction in 540. When displaying a content notification interface on a screen of the primary terminal 10, the primary terminal 10 transmits a content notification message to the secondary terminal 20 to control the content request interface to be displayed on a screen of the secondary terminal 20.

In response to an input of a multi-screen content request instruction from a user through a content request interface, the secondary terminal 20 transmits a message of request for multi-screen service context information to the primary terminal 10 in 550. After receiving the message, the primary terminal 10 transmits a response message including broadcast content identification and multi-screen content metadata to the secondary terminal 20 in 560.

Next, the secondary terminal 20 transmits the service context information received from the primary terminal 10, along with user information, to a secondary content provider 22 to request multi-screen content in 570. The user information includes a user identification (ID) to identify users as well as terminal information of the secondary terminal 20. The terminal information includes a terminal identification, and multi-screen service connection status of a terminal.

After receiving the multi-screen request message, the secondary content provider 22 uses service context information to produce multi-screen content based on broadcast content, and uses user information to provide multi-screen content to the secondary terminal 20 in 580.

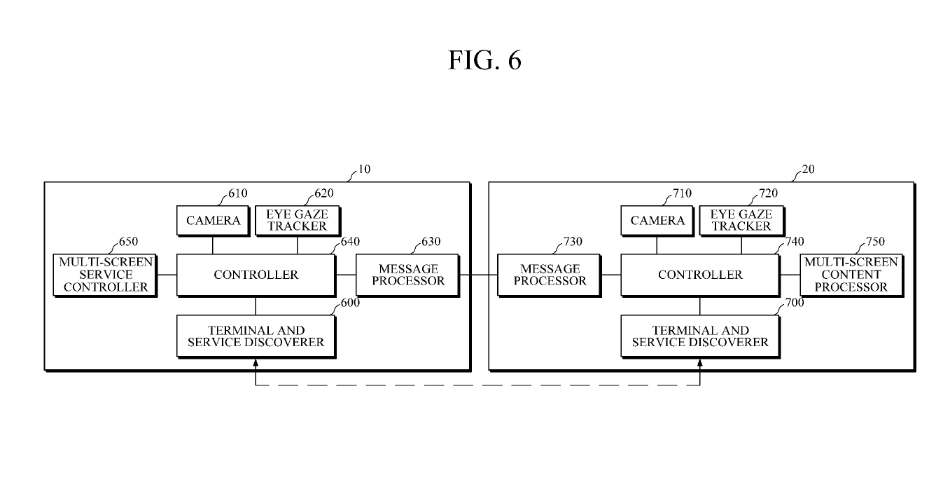

FIG. 6 is a detailed block diagram illustrating an example of a primary terminal and a secondary terminal according to an exemplary embodiment.

Referring to FIGS. 1 and 6, the primary terminal 10 includes a terminal and service discoverer 600, a camera 610, an eye gaze tracker 620, a message processor 630, a controller 640, and a multi-screen service controller 650.

The terminal and service discoverer 600 of the primary terminal 10 discovers the secondary terminal 20 and a multi-screen service. To this end, the terminal and service discoverer 600 may use existing service discovery protocols, such as UPnP, Bonjour, mDNS, WebIntent. The camera 610 acquires captured image information of a user's eye gaze viewing broadcast content through a screen of the primary terminal 10. The acquired image information is transmitted to the eye gaze tracker 620. The eye gaze tracker 620 identifies and tracks a user's eye gaze based on image information, in which detection may be determined as to whether the user's eye gaze is diverted from the primary terminal 10. According to an exemplary embodiment, image information of a user is acquired from the camera 610, but an acquiring device is not limited thereto, and any device capable of acquiring image information may also be used.

The message processor 630 performs message communications between the primary terminal 10 and the secondary terminal 20 used at the same time. According to an exemplary embodiment, in response to detecting that a user's eye gaze is diverted from the primary terminal 10, the message processor 630 transmits, to the secondary terminal 20 being used by the user, a message notifying that the user's eye gaze is diverted. After receiving a message of request for service context information from the secondary terminal 20, the message processor 630 transmits a service context response message including service context information to the secondary terminal 20. The service context information may include an identification (ID) of content being viewed by a user and content metadata, a point where a user's eye gaze is diverted, coordinates of a tracked eye gaze immediately before an eye gaze is diverted, etc.

The controller 640 processes message control information transmitted and received by the message processor 630, and delivers parsed data to each functional block. The multi-screen service controller 650 analyzes multi-screen content metadata information related to broadcast content, and controls multi-screen service using information on eye gaze recognition and tracking performed by the eye gaze tracker 620.

The secondary terminal 20 includes a terminal and service discoverer 700, a camera 710, an eye gaze tracker 720, a message processor 730, a controller 740, and a multi-screen content processor 750.

The terminal and service discoverer 700 of the secondary terminal 20 automatically discovers the primary terminal 10 and a multi-screen service. To this end, the terminal and service discoverer 700 may use existing devices and service discovery protocols, such as UPnP, Bonjour, mDNS, WebIntent. The camera 710 acquires captured image information of a user's eye gaze. The acquired image information is transmitted to the eye gaze tracker 720. The eye gaze tracker 720 identifies and tracks a user's eye gaze based on image information.

The message processor 730 performs message communications with the primary terminal 10. According to an exemplary embodiment, in response to detecting that a user's eye gaze is directed toward the secondary terminal 20, the message processor 730 transmits a message of request for service context information to the primary terminal 10, and receives from the primary terminal 10 a service context response message including service context information. The service context information may include an identification (ID) of content being viewed by a user and content metadata, a point where a user's eye gaze is diverted, coordinates of a tracked eye gaze immediately before an eye gaze is diverted, etc. According to an exemplary embodiment, the message processor 730 transmits, to the secondary content provider 22, a message of request for multi-screen content including user information along with the service context information received from the primary terminal 10, and receives from the secondary content provider 22 multi-screen content based on broadcast content.

The controller 740 processes message control information transmitted and received by the message processor 730, and delivers parsed data to each functional block. The multi-screen content processor 750 processes multi-screen service context information, received from the primary terminal 10, so as to perform in conjunction with the secondary content provider 22.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A method for providing multi-screen based content of a primary terminal, the method comprising:
connecting to at least one of secondary terminals each with a screen;
tracking an eye gaze of a user that uses primary content through the primary terminal to detect an eye movement of the user from the primary terminal to the at least one secondary terminal; and
in response to detecting the eye movement of the user, transmitting, to the at least one secondary terminal, context information required for the at least one secondary terminal to receive secondary content related to the primary content.

2. The method of claim 1, wherein:
the primary terminal is a broadcast receiver that receives the primary content through a broadcast network and displays the received primary content on a screen; and
the at least one secondary terminal is a multi-screen device that receives the secondary content through Internet and displays the received secondary content on each screen of the secondary terminals.

3. The method of claim 2, wherein:
the broadcast receiver is a TV set; and
the multi-screen device is a portable terminal.

4. The method of claim 2, wherein:
the primary content is broadcast content, and the secondary content is multi-screen content comprising additional content related to the broadcast content.

5. The method of claim 1, wherein the connecting to the at least one of secondary terminals comprises:
executing a multi-screen service of the primary terminal by a user; and
connecting to a home network along with the at least one secondary terminal, of which multi-screen service is executed by the user, to discover the at least one secondary terminal and a multi-screen service.

6. The method of claim 1, wherein the detecting the eye movement of the user comprises:
identifying a face of the user viewing the primary content;
tracking an eye gaze of the user, whose face is identified, to detect whether the user's eye gaze is diverted from the primary terminal;
in response to detecting that the user's eye gaze is diverted from the primary terminal, notifying, to the at least one secondary terminal, that the user's eye gaze was diverted from the primary terminal.

7. The method of claim 1, wherein the context information to be transmitted to the at least one secondary terminal comprises a primary content identifier, primary content metadata, a point where an eye gaze is diverted, and coordinates of a tracked eye gaze immediately before the eye gaze is diverted.

8. The method of claim 1, further comprising:
tracking the user's eye gaze to detect coordinates of the tracked eye gaze immediately before the eye gaze is diverted from the primary terminal; and
using the detected coordinates of the tracked eye gaze to identify a scene of interest and an object of interest of the user.

9. A method for receiving multi-screen based content of at least one of secondary terminals each with a screen, the method comprising:
connecting to a primary terminal that receives and displays primary content;
detecting an eye movement from the primary terminal to the at least one secondary terminal of a user viewing the primary content through the primary terminal;
in response to detecting the user's eye movement, requesting and receiving, from the primary terminal, context information on the primary content; and
transmitting user information along with the received context information to a content provider to receive secondary content related to the primary content from the content provider.

10. The method of claim 9, wherein the connecting to the primary terminal comprises:
executing a multi-screen service of the secondary terminal by the user; and
connecting to a home network along with the primary terminal, of which multi-screen service is executed by the user, to discover the primary terminal and a multi-screen service.

11. The method of claim 9, wherein the detecting of the user's eye movement comprises:
receiving, from the primary terminal, a message notifying that the user's eye gaze was diverted from the primary terminal; and
tracking the user's eye gaze, which was diverted from the primary terminal, to detect that the user's eye gaze is directed toward the secondary terminal.

12. The method of claim 9, wherein the context information received from the primary terminal comprises a primary content identifier, a primary content metadata, a point where an eye gaze is diverted, and coordinates of a tracked eye gaze immediately before the eye gaze is diverted.

13. A method for providing multi-screen based content of a primary terminal, comprising:
connecting to at least one of secondary terminals each with a screen;
obtaining metadata of secondary content related to primary content reproduced through the primary terminal;
analyzing the obtained metadata of the secondary content to detect a point of reproduction of the primary content related to the secondary content, and to display a content notification interface at the detected reproduction point; and
based on the displayed content notification, when an instruction to receive the secondary content is input to the at least one secondary terminal from a user through a content request interface, providing context information to the at least one secondary terminal at the request of the at least one secondary terminal.

14. The method of claim 13, wherein:
the primary terminal receives the primary content through a broadcast network to display the received primary content on a screen, and is a broadcast receiver that obtains metadata of the secondary content through a broadcast network or Internet; and
the at least one secondary terminal is a multi-screen device that receives the secondary content through Internet to display the received secondary content on each screen of the secondary terminals.

15. The method of claim 13, wherein:
the broadcast receiver is a TV set; and
the multi-screen device is a portable terminal.

16. The method of claim 14, wherein:
the primary content is broadcast content, and the secondary content is multi-screen content comprising additional content related to the broadcast content.

17. The method of claim 13, wherein the connecting to the at least one secondary terminal comprises:
executing a multi-screen service of the primary terminal by the user; and
connecting to a home network along with the at least one secondary terminal, of which multi-screen service is executed by the user, to discover the at least one secondary terminal and a multi-screen service.

18. The method of claim 13, wherein in the providing of the context information to the at least one secondary terminal, the context information provided to the at least one secondary terminal comprises an identifier of the primary content and metadata of the secondary content.

19. The method of claim 13, wherein the displaying of the content notification interface comprises displaying the content notification interface and transmitting a content notification message to the at least one secondary terminal, so that the secondary terminal displays the content request interface.
